(19) United States
(12) Patent Application Publication
(10) Pub. No.: US 2003/0009599 A1
(43) Pub. Date: Jan. 9, 2003

(54) Protecting ring network data

(75) Inventors: Charles Lee, Ashland, MA (US); Harsh Kapoor, Boxborough, MA (US); Jonathan Morgan, Groton, MA (US)

Correspondence Address: HALE AND DORR, LLP, 60 STATE STREET, BOSTON, MA, 02109

(73) Assignee: Appian Communications, Inc., Acton, MA

(21) Appl. No.: 10/137,722

(22) Filed: May 2, 2002

Related U.S. Application Data
(60) Provisional application No. 60/288,901, filed on May 4, 2001.

(51) Int. Cl. G06F 15/16

(52) U.S. Cl. 709/251

(57) ABSTRACT

A ring is configured that has multiple nodes connected by first and second channels. A distributing filter is provided that is configured to direct a first type of data to the first channel in the ring and a second type of data to the second channel in the ring. A fault is detected on at least one of the first and second channels in the ring. The distributing filter is adjusted to redirect data in the ring to avoid the fault.

### CROSS-REFERENCE TO RELATED APPLICATIONS

This application claims the benefit of U.S. Provisional Application No. 60/288,901, entitled “PROTECTING RING NETWORK DATA” filed on May 4, 2001, which is incorporated herein by reference in its entirety.

### BACKGROUND

This application relates to protecting ring network data.

A communication network typically includes a large number of nodes connected by transmission lines. In a modern network, these transmission lines are often optical fibers. Such fibers are extremely thin and therefore susceptible to mechanical breakage. In addition, because fibers are so thin, the alignment between fibers at a junction must be extremely precise. These junctions are therefore easily disrupted by mechanical shock or vibration. Even slight kinks or bends in a fiber can cause internal reflections that lead to significant degradation in signal quality.

Although attempts are made to isolate a fiber from mechanical disturbance, reliable isolation remains difficult. Buried fibers routinely fall prey to backhoes in construction accidents. Over the years, the accumulated effect of the vibration of passing subway trains can gradually degrade communication. Not all disruptions (also known as “faults”) result from human activity, however. Even a minor earthquake can cause isolated disruptions in service.

A network can also fail as a result of disruption within a node. For example, the laser at the transmitting end of each fiber can gradually deteriorate. Since nodes can include complex electronic systems, they too are subject to failure from a variety of causes.

To avoid excessive service disruption in the event of network failure, it is desirable to provide the network with redundancy. One method of achieving this is to arrange the nodes of a communication network in a ring and to connect the nodes with two independent fibers: a working fiber and a protection fiber. A ring connected in this way is referred to in the art as a Unidirectional Path Switched Ring (“UPSR”).

In a UPSR, a source node transmits two copies of a data frame to a destination node. A working copy of the data frame travels clockwise around the ring on the working fiber and a protection copy of the frame travels counter-clockwise around the ring on the protection fiber. If the destination node finds that the protection copy matches the working copy, it accepts the working copy. Otherwise, the destination node selects the better of the two copies.

As it makes its way to the destination node from the source node, a data frame can pass through many other nodes. In these intervening nodes, there may be data packets queued for transmission on the ring. In addition, there may be space within the data frame for accommodating some of these data packets. Because these empty spaces represent a waste of network resources, it would be useful to accommodate some of these queued data packets in those spaces.

Unfortunately, as soon as the data frame accepts a data packet from a node other than the source node, the working copy of the data frame will inevitably differ from the protection copy of the frame. Thus, upon comparing the working copy with the protection copy, the destination node will receive two different frames with no way to determine whether the difference is the result of additional data on the frame or a disruption in transmission.

### SUMMARY OF THE INVENTION

A method and a system are provided for protecting ring network data. In particular, a ring is configured with multiple nodes connected by first and second channels. A distributing filter is provided and is configured to direct a first type of data to the first channel in the ring and a second type of data to the second channel in the ring. A fault is detected on at least one of the first and second channels in the ring. The distributing filter is adjusted to redirect data in the ring to avoid the fault.

The distributing filter may include a mechanism that distributes data over multiple channels, which distribution may or may not be executed in accordance with one or more predefined schemes such as a priority based scheme, a capacity based scheme, or a random distribution based scheme.

A communication network according to the invention circumvents difficulties by providing nodes in which each node adopts a signaling protocol that informs other nodes in the network of the condition of the signals arriving at that node from an adjacent node. In response to these signals, each node makes an independent decision as to whether to bypass its adjacent nodes on the network.

When a disruption occurs, there will be a first node and a second node adjacent to, and on either side of, the disruption. Upon the detection of the disruption, the first node signals each of the other nodes to cause that other node to determine if it is the second node, and, if so, to identify itself as such. If it is not, that node continues to operate in its normal mode. However, if that node determines that it is the second node, it sends an acknowledgement signal back toward the first node and redirects data between the first and second channels, thereby preventing data from proceeding further toward the disruption. Upon receipt of the acknowledgement, the first node likewise redirects data between the first and second channels, thereby preventing data from proceeding further toward the disruption. This results in the isolation of that disruption and the combination of the first and second channels to form a new ring that excludes the disruption.

The system and method may be implemented using standard Ethernet components, and the redirection of data may be accomplished in a way that is transparent to a node's operations that are unrelated to the ring network. The system and method may be implemented and/or exercised on a network that is based on conventional Ethernet technology, e.g., to add resilience or to render the network highly effective for a particular purpose by increasing resilience to a satisfactory level.

Ring network data can thus be protected in a distributed solution that provides resiliency, ease of maintenance and implementation, and interoperability with IEEE 802.17 and other proposed technology.

These and other features of the invention will be apparent upon review of the following detailed description, claims, and the accompanying figures.

### BRIEF DESCRIPTION OF THE DRAWINGS

FIG. 1 shows a network in which a working trunk and a protection trunk connect a plurality of nodes into a ring;

FIGS. 2-3 illustrate portions of a typical node from the ring of FIG. 1 showing an internal architecture for protection of data following a signal fault on the working channel;

FIGS. 4A-4F show the state of a ring network at various times following a disruption in the network; and

FIGS. 5-6 are flow charts illustrating data protection methods.

### DETAILED DESCRIPTION

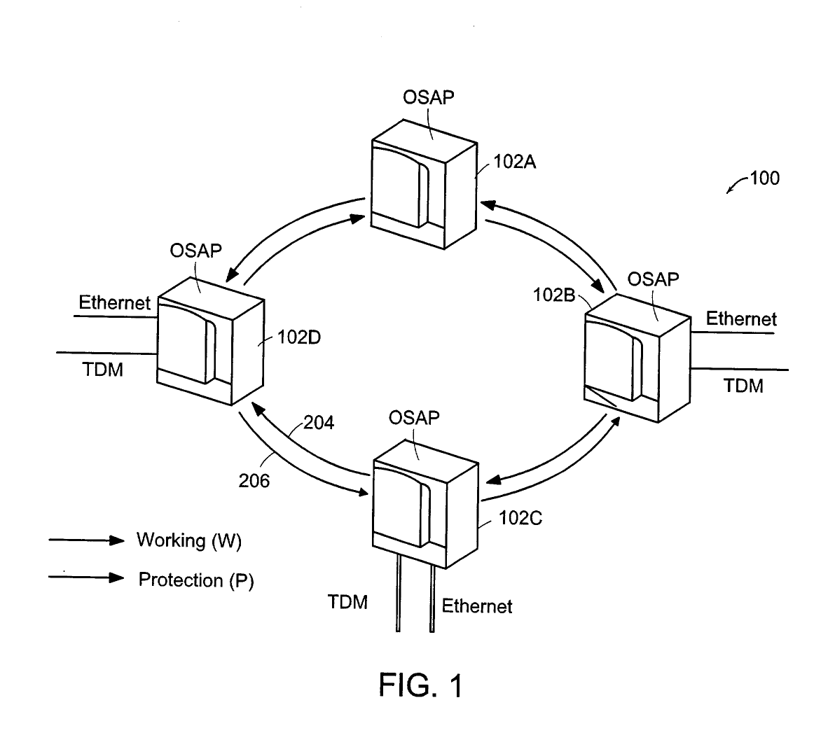

FIG. 1 illustrates a resilient network ring architecture (“ring”) 100 in which, by example, nodes 102A-102D (labeled “OSAP” for Optical Services Activation Platform, which may include technology from Appian Communications, Inc.) are linked by working and protection trunks (“channels”) 204, 206. In a specific embodiment, each channel 204, 206 includes optical fibers for optical transmission of data, but in other embodiments optical fibers could be supplemented or replaced by other data communications technology such as coaxial cables or wireless transceivers.

In ring 100, each node (e.g., node 102B) is connected to adjacent nodes (e.g., nodes 102A, 102C) by working channel 204 and protection channel 206. Channels 204, 206 carry signals in opposite directions in ring 100. For example, as shown in FIG. 1, working channel 204 may carry a signal in a clockwise direction around ring 100 and protection channel 206 may carry a signal in a counterclockwise direction around ring 100. Some or all of the nodes may have time division multiplexing (“TDM”) or Ethernet connection or both, as shown in FIG. 1, for communicating data to and from the ring.

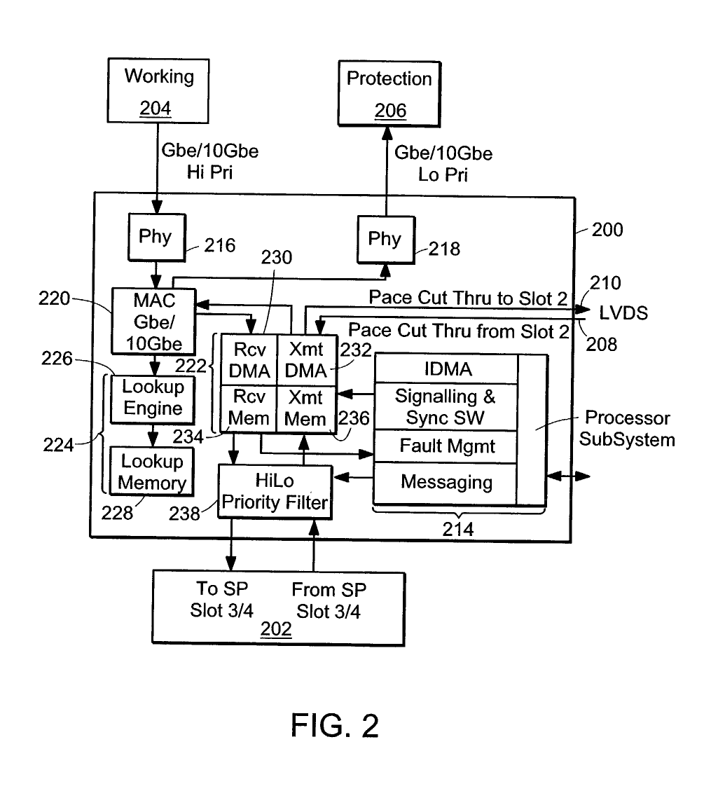

FIG. 2 illustrates pertinent data transmission and data reception logic within a typical node. A resilient packet ring (RPR) network device (e.g., card) 200 provides an interface, in a node such as node 102A, between node equipment 202 and the working and protection channels 204, 206. Card 200 also has input and output low voltage differential signal (“LVDS”) connections 208, 210 that may be routed to a companion card for use in packet circuit emulation (“PACE”) technology as described below, and has fault handling logic 214 that operates as described below.

Card 200 has a first physical layer interface device (“PHY”) 216 for receiving incoming data from working channel 204 and has a second PHY 218 for transmitting outgoing data on protection channel 206. Card 200 also has a media access controller (“MAC”) 220 that provides an interface between PHYs 216, 218 and memory logic 222, 224. The PHYs and the MAC may have capabilities compatible with SONET, IEEE 802.3, or any variant, such as Gigabit or 10 Gigabit Ethernet. For example, a Broadcom or Intel Ethernet device such as the Intel 21440 multiport 10/100 Mbps Ethernet controller may be used.

MAC 220 helps to transfer incoming data from PHY 216 to memory logic 222 and outgoing data from memory logic 222 to PHY 218. MAC 220 also transfers incoming data from PHY 216 to memory logic 224 that includes a lookup engine 226 and a lookup memory 228. In a specific implementation, the lookup engine distinguishes among different classes or types of data traffic and uses the lookup memory to determine how to treat data traffic based on its class or type. The lookup memory may hold one or more tables of data that supplies guidance for directing or otherwise treating the data traffic.

Memory logic 222 has receive and transmit DMA logic 230, 232 and corresponding receive and transmit memories 234, 236. DMA logic 230, 232, together with MAC 220, causes incoming and outgoing data to be transferred between PHYs 216, 218 and receive and transmit memories 234, 236, respectively.

Card 200 also has a priority filter 238 that provides an interface between the service provider equipment 202 and memory logic 222. Under normal circumstances, filter 238 causes only high priority incoming data to be transferred from memory logic 222 to equipment 202, and causes only low priority data to be transferred from equipment 202 to memory logic 222.

Fault handling logic 214 responds to fault indications from memory logic 222, and, under certain circumstances as described below, can reconfigure memory logic 222 and priority filter 238 to cause card 200 to form a bridge redirecting data between working channel 204 and protection channel 206.

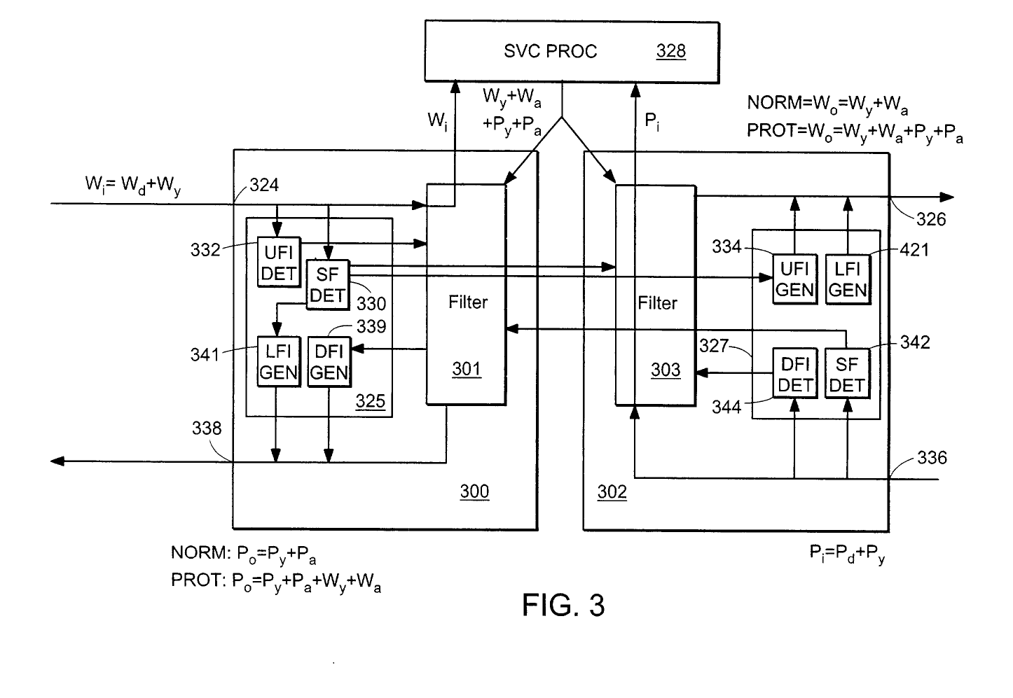

FIG. 3 shows a schematic illustration of a portion of the data protection system within a typical node. For the sake of simplicity in illustration and exposition, FIG. 3 shows only the portion of the data protection system associated with monitoring a signal on an inbound working channel. In addition, because each of the nodes 102A-102D has the same architecture and logic, reference numerals for parts shown in FIG. 3 are used in connection with subsequent descriptions of the operation of each node.

The typical node shown in FIG. 3 includes first and second RPR network cards 300, 302, each of which includes an instance of the card 200 logic described above. However, cards 300, 302 are connected differently. Card 300 is connected as described above for card 200, i.e., with a working channel input 324 to receive data on the working channel and a protection channel output 338 to transmit data on the protection channel. Card 302 has the reverse connections: a protection channel input 336 to receive data from the protection channel and a working channel output 326 to transmit data to the working channel.

Working channel input 324 carries a signal normally routed to working channel output 326 via service processing logic 328 that is included in equipment 202 described above. Working channel input 324 and working channel output 326 are connected to an inbound working channel and an outbound working channel respectively.

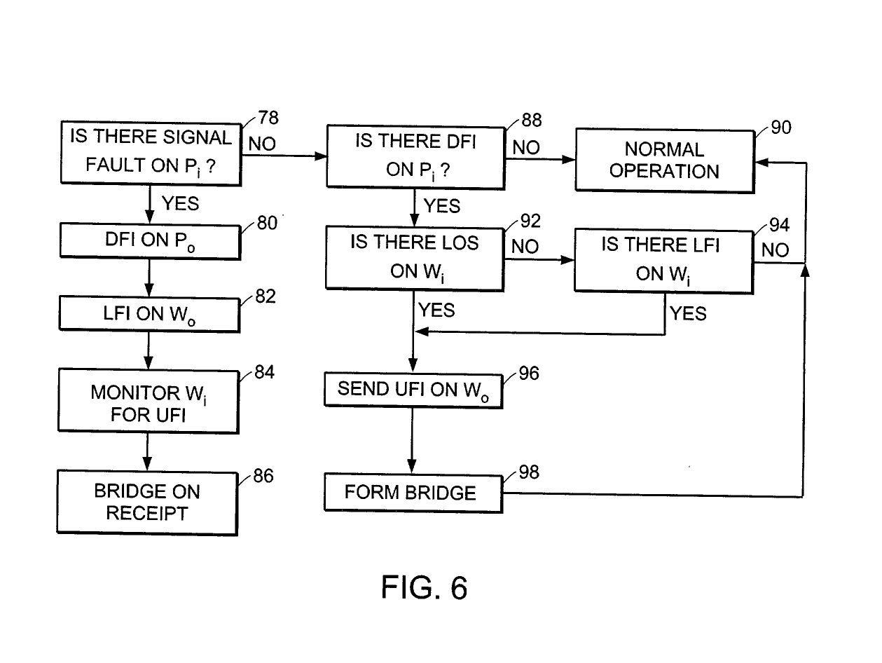

Working channel input 324 is monitored by fault handling logic 325 (i.e., fault handling logic 214 of FIG. 2), which includes a first signal fault detector 330 and an upstream fault indication (“UFI”) signal detector 332. The working channel output 326 is in communication with fault handling logic 327 having a UFI generator 334 for generating a UFI signal to be detected by a UFI detector monitoring a working channel input 324 of an adjacent downstream node on the working channel. Logic 327 also has a first LFI (Local Fault Indication) generator 421 in communication with the working channel output 326. This first LFI generator 421 is used only in conjunction with the detection of a signal fault on the protection channel, as is discussed below in connection with FIG. 6.

Protection channel input 336 carries a signal normally routed to protection channel output 338 via logic 328. Protection channel input 336 and protection channel output 338 are connected to an inbound protection channel and an outbound protection channel respectively. Fault handling logic 325 includes a Downstream Fault Indication (“DFI”) generator 339 and a second LFI generator 341, both of which are in communication with protection channel output 338 for sending a signal to an adjacent downstream node. Logic 327 includes a second signal fault detector 342 and a DFI signal detector 344 that monitor protection channel input 336 for the presence of a signal fault or a DFI signal respectively.

UFI detector 332, DFI detector 344, and first and second signal fault detectors 330, 342 operate to control the data flow through cards 300, 302 by controlling respective priority filters 301, 303. A potential change to priority filter 301 is set up in response to a detection by UFI detector 332 and is completed in response to a detection by the second signal fault detector 342; a potential change to priority filter 303 is set up in response to a detection by first signal fault detector 330 and is completed in response to a detection by the DFI detector 344.

Under normal circumstances, the data flow through the typical node of FIG. 3 is as follows (see also International Publication Number WO 01/78276 A1 entitled DATA PROTECTION IN A RING NETWORK, which is incorporated herein by reference in its entirety). Working channel input 324 receives data Wi that includes data Wd that is specific to the instant node (and that will therefore be “dropped” or “deposited” at the instant node) and other data Wy that is not specific to the instant node (and that therefore will be passed along to the next node). Similarly, protection channel input 336 receives data Pi that includes data Pd that is specific to the instant node and other data Py that is not specific to the instant node. (In a specific implementation, the working channel normally carries only high priority data, and the protection channel normally carries only low priority data, but other arrangements are possible, including one or more arrangements using a basis other than priority.) All of data Wi and all of data Pi pass through filters 301, 303 to logic 328, where data Wd and data Pd are extracted. Logic 328 transmits data Wy and Py, along with new data Wa and Pa (i.e., “added” data), back to both filters 301, 303. Filter 301 passes only data Py and Pa (collectively “Po”) to protection channel output 338, and filter 303 passes only data Wy and Wa (collectively “Wo”) to working channel output 326.

Under certain circumstances such as a disruption as described below, one or both of filters 301, 303. and consequently one or both of respective cards 300, 302, may be placed in bridge mode (also called “protection mode” or “bridged state”). In the case of filter 301, bridge mode causes all of data Wy, Py, Wa, and Pa to be passed from logic 328 to output 338. In the case of filter 303, bridge mode causes all of data Wy, Py, Wa, and Pa to be passed from logic 328 to output 326. Since logic 328 sends all of data Wy, Py, Wa, and Pa to both filters 301, 303, bridge mode does not necessarily result in any change to the operation of logic 328. Thus, in at least some cases, bridge mode can be adopted by one or more of cards 300, 302 to respond to an event such as a disruption in a way that is transparent and nonintrusive to logic 328 and to a system that communicates with the working and protective channels via logic 328.

The manner in which a ring of nodes having the architecture shown in FIG. 1 reconfigures the ring following a service disruption will be apparent from a detailed analysis of an example in which a disruption causes a signal fault on an inbound working channel leading to a node. The cause of the disruption is immaterial to the operation of the system. The disruption can arise from a fiber cut of one or both fibers that carry that channel, a degradation of a signal carried by one or more channels in one or both fibers, or from a disruption of an entire node. What is significant is that a signal fault in any fiber leading to any node in the ring initiates a sequence of events that inevitably results in the reconfiguration of the ring to avoid the disruption.

In the detailed analysis below, a numeric correspondence is established with the elements of FIG. 3 such that, for example, working channel input 524 corresponds to working channel input 324 of FIG. 3, and protection channel input 536 corresponds to protection channel input 336 of FIG. 3.

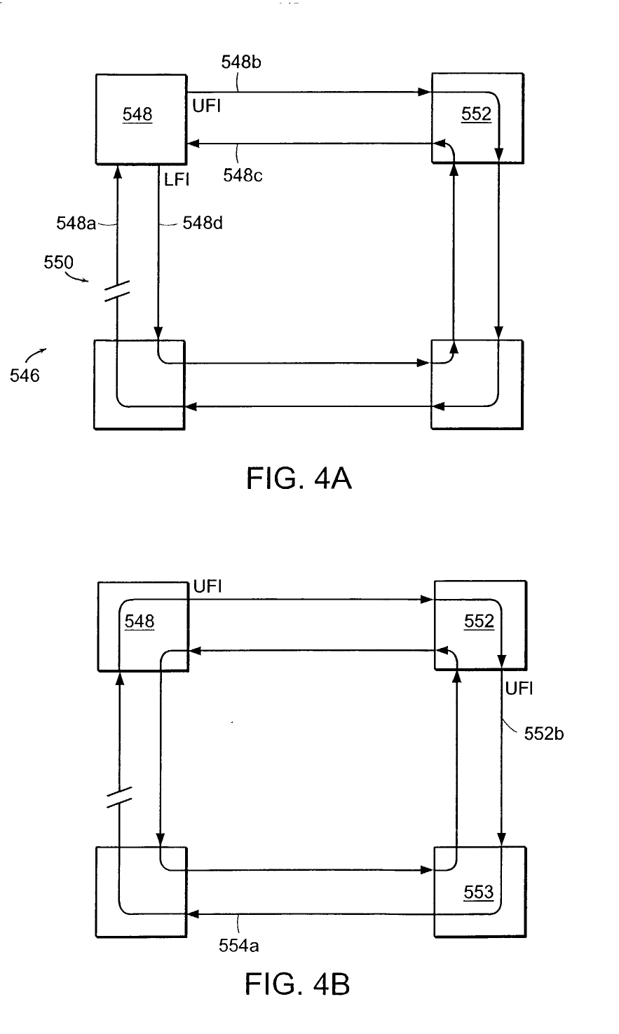

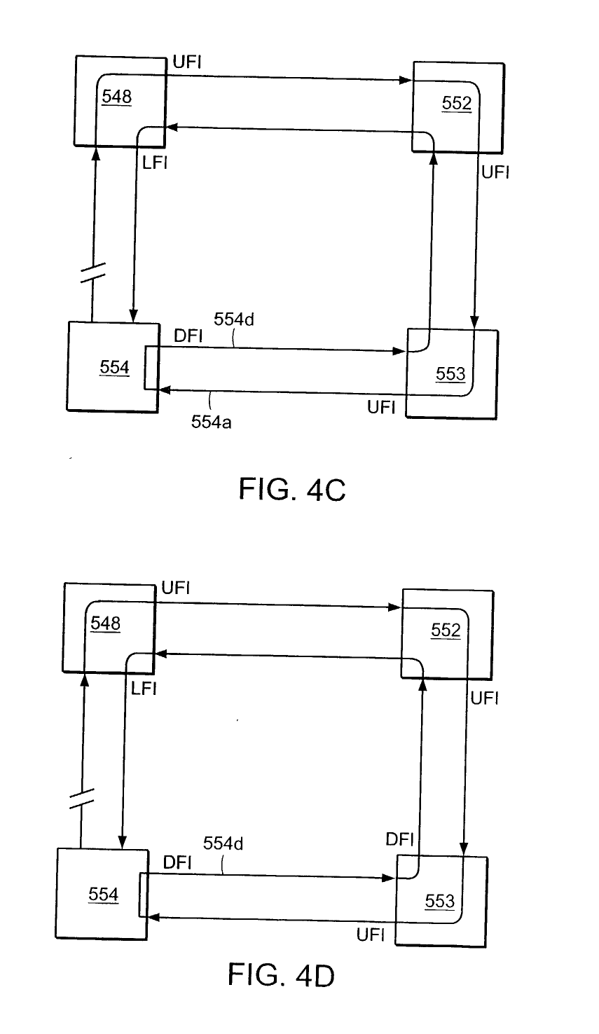

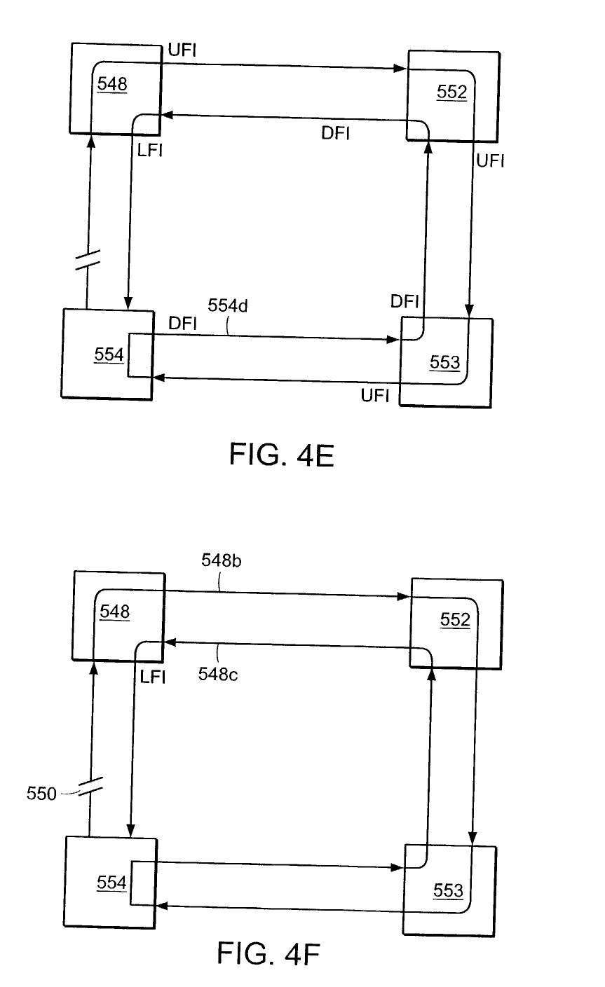

Referring now to FIG. 4A, a ring 546 includes a first node 548 in communication with an inbound working channel 548a, an outbound working channel 548b, an inbound protection channel 548c, and an outbound protection channel 548d. These channels are connected to the working channel input 524, the working channel output 526, the protection channel input 536, and the protection channel output 538 of the first node 548 respectively. A disruption-550 in the inbound working channel 548a results in the detection of a signal fault by the first node 548.

With reference also to FIG. 3, within the first node 548, the first signal fault detector 530 monitors its working channel input 524 for a signal fault. A signal fault can be a total loss of a signal or merely a degradation of a signal. In either case, if the first signal fault detector 530 detects a signal fault at the working channel input 524, it instructs the UFI generator 534 to place a UFI signal on the working channel output 526, and instructs the second LFI generator 541 to place an LFI signal at the protection channel output 538.

With reference to FIG. 4A as a result of the disruption 550 in the inbound working channel 548a, the UFI generator 534 of the first node 548 operates in the manner described above to place a UFI signal on its outbound working channel 548b and an LFI signal on its outbound protection channel 548d. This results in the UFI and LFI signals shown in FIG. 4A. Note that the UFI signal is now present on the signal entering a second node 552. The operation of this second node 552 is best understood with reference to FIG. 3.

With reference also to FIG. 3, the working channel input 524 is also monitored by the UFI detector 532. In response to the existence of a UFI signal on the working channel input 524, the UFI detector 532 sets up a potential change to filter 301 to place respective card 300 in its bridged state upon the occurrence of either a signal loss or an LFI signal on the protection channel input 536.

The second node 552 passes the signal present at its working channel input 524 to its working channel output 526. This places the ring 546 in the state shown in FIG. 4B, in which the UFI signal originally generated at the first node 548 is provided to a third node 553 by way of an outbound working channel 552b.

The third node 553 is identical to the second node 552 and reacts to the UFI signal in the same manner as already described above. The third node thus provides the UFI signal, originally generated by the first node 48, to the working channel input of the fourth node 554, as shown in FIG. 4C.

The internal architecture of the fourth node 554 is identical to that of the second node 552. Consequently, the operation of the fourth node 554 in response to the UFI signal present on its inbound working channel 554a is identical to that described above in connection with the second node 552. In the fourth node 554, therefore, a potential change to filter 301/303 is set up by its UFI detector 532 in response to the UFI signal now present on the inbound working channel 554a.

Consistent with the foregoing discussion of the operation of the first signal fault detector 530, the first node 548, in response to the existence of a signal fault at its working channel input 524, instructed its second LFI generator 541 to place an LFI signal at its protection channel output 538. This LFI signal is therefore present on the protection channel input 536 of the fourth node 554. Because it has been set up by the UFI detector 532, the change to filter 301 is completed to place card 300 in a W-to-P (working input to protection output) bridged state. In this state, the card 300 redirects data traffic on the inbound working channel 554a to the outbound protection channel 554d. In addition, the completed change to filter 301 causes the DFI generator 539 to place a DFI signal on the protection channel output. This places the ring 546 in the state shown in FIG. 4C.

If both the protection channel and the working channel are cut, or if a node fails altogether, it may be impossible for a node to detect an LFI signal. In order to extend the operation of the data protection system to such cases, it is preferable for the fourth node 554 to treat a loss of signal in the same manner as an LFI signal.

The DFI signal present on the outbound protection channel 554d associated with the fourth node 554 now propagates back through the third node 553, as shown in FIG. 4D, and through the second node 552, as shown in FIG. 4E. Because neither the third node 553 nor the second node 552 ever transmitted an LFI signal out their respective protection channel outputs 538, neither of those nodes ever set up a filter change with respect to their respective DFI detectors 544. As a result, the DFI signal is passed unimpeded to the protection channel input of the first node 548.

With reference also to FIG. 3, the first node 548 did send an LFI signal on its protection channel output 538. As a result, the first signal fault detector 530 of the first node 548 set up a change to filter 303 of the first node 548. Therefore, the change to filter 303 is ready to be completed upon receipt, by the first node 48, of a DFI signal on the protection channel input 536. This DFI signal is provided by the second node 552, as shown in FIG. 4E. Upon receipt of this DFI signal, the change to filter 303 is completed, which places card 302 in a P-to-W (protection input to working output) bridged state. This places the ring 546 in the state shown in FIG. 4F, in which traffic entering the first node 548 on its inbound protection channel 548c is routed to its outbound working channel 548b, thereby reconfiguring the ring 546 to avoid the disruption 550.

The control signals including UFI, DFI, and LFI may be transmitted using standard Ethernet packets or any other network technology supported by the PHYs and MAC. Addressing in the ring may use Multiprotocol Label Switching (“MPLS”) which is a label-swapping standard for Layer 3 switching and which is related to routing, i.e., helping to determine the path through which a packet is being sent through a network.

It is apparent that only one node in the ring 546 detects the fault on its inbound working channel and that only one node in the ring detects the LFI signal (or a loss of signal) on its inbound protection channel. As a result, only two nodes can be in a position to form a bridge. These two nodes are inevitably those nodes that are adjacent to the disruption 550.

In a specific implementation, the LVDS connections mentioned above may be used to allow time sensitive data that is not specific to the instant node to be transmitted through the instant node, i.e., between the two cards 300, 302 of the instant node, without passing through the priority filter of either card. For example, the time sensitive data may include PACE packets serving TDM functions.

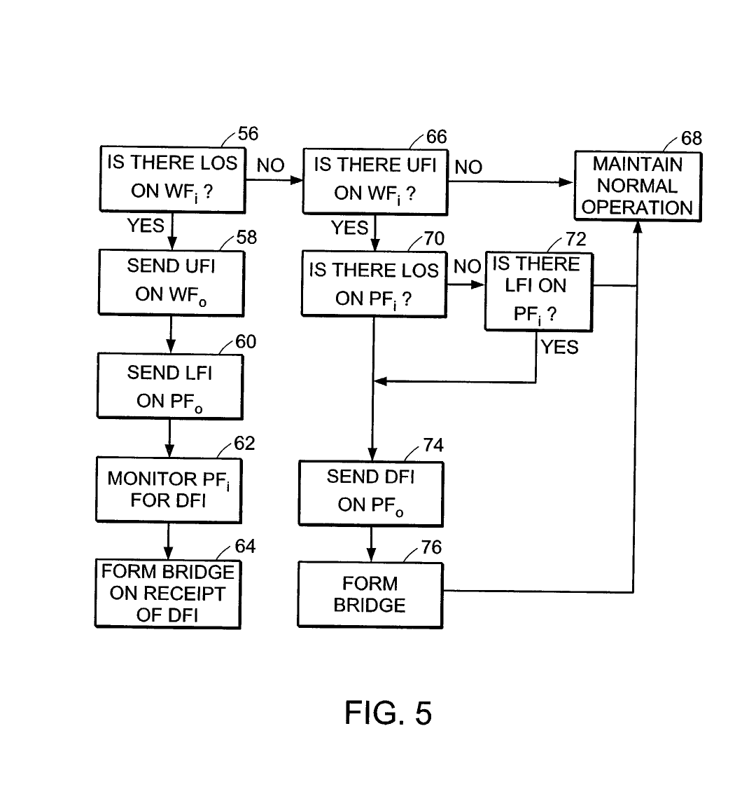

FIG. 5 is a flow chart summarizing the operation of a typical node in the data protection method of the invention. As shown in FIG. 5, a node first checks to determine whether there exists a signal fault on its inbound working channel (step 56). If there is, the node transmits a UFI on the outbound working channel (step 58) and sends an LFI signal on its outbound protection channel (step 60). The node then monitors its inbound protection channel for the presence of a DFI signal (step 62). Upon receipt of a DFI signal, the node then forms a bridge, thereby routing traffic from its inbound protection channel to its outbound working channel (step 64).

If there is no fault present on its inbound working channel, the node checks to see if there is a UFI on its inbound working channel (step 66). If there is no UFI on its inbound working channel, then the ring is operating, normally and no further action need be taken (step 68). However, if there is a UFI on-its inbound working channel, the node must determine whether it is to form a bridge.

To determine whether it is to form a bridge, the node examines its inbound protection channel to determine whether there is either a loss of signal (step 70) or a signal fault (step 72). If neither of these are present on its inbound protection channel, the node recognizes that there is no need for it to form a bridge (step 68). If either a loss of signal or a signal fault is present on its inbound protection channel, the node sends a DFI signal on its outbound protection channel to signal whichever node initiated the data protection process that one bridge has been formed and that it too should form a Midge (step 74). At the same time, or shortly thereafter, the node forms a bridge, thereby routing traffic from its inbound working channel to its outbound protection channel (step 76).

The foregoing discussion describes the structure and operation of the system in connection with a disruption in the working channel. The operation of the system in connection with a disruption of a signal on the protection channel proceeds in an analogous manner, as indicated by the flow chart of FIG. 6.

Referring to FIG. 6, when a first node detects a signal fault on its inbound protection channel (step 78), it sends a DFI signal on its outbound protection channel (step 80) and an LFI signal on its outbound working channel (step 82). The DFI signal propagates around the ring in the same manner that the UFI signal propagated around the ring when the signal fault was on the inbound working channel instead of the inbound protection channel. The first node then waits for a UFI signal on its working channel (step 84) and, upon receipt of such a signal, forms a bridge (step 86).

A second node that does not detect a signal fault on its inbound protection channel monitors its inbound protection channel for a DFI signal indicating a fault somewhere on the protection channel (step 88). If it detects no such DFI signal, the second node remains in its normal operating state (step 90). If it does detect such a signal, it must then determine whether it should form a bridge. To do so, the second node monitors the inbound working channel for either a loss of signal (step 92) or the presence of the LFI signal generated by the first node (step 94). If neither of these is present, the second node recognizes that it need not form a bridge, and it therefore remains in its normal operating mode (step 90). However, if the second node detects either an loss of signal or an LFI signal on the inbound working channel, it sends a UFI signal on its outbound working channel (step 96). It is this UFI signal that the triggers the formation of a bridge by the first node (steps 84 and 86).

The data protection system of the invention thus includes a system for protection of data on the working channel operating in parallel with an analogous system for the protection of data on the protection channel. In addition, because the ring 546 has the same configuration as a UPSR, the conventional UPSR data protection system can operate in parallel with the data protection system of the invention.

The technique (i.e., the procedures described above) may be implemented in hardware or software, or a combination of both, that may form a control plane and a data plane. In at least some cases, it is advantageous if the technique is implemented in computer programs executing on one or more programmable computers, such as an embedded system or other computer running or able to run VxWorks (or Microsoft Windows 95, 98, 2000, Millennium Edition, NT; Unix; Linux; or MacOS); that each include a processor such as a Motorola PowerPC 8260 (or an Intel Pentium 4) possibly together with one or more FPGAs (field programmable gate arrays, e.g., by Xilinx, Inc.), a storage medium readable by the processor (including volatile and non-volatile memory and/or storage elements), possibly with at least one input device (e.g., a keyboard), and at least one output device. Program code is applied to data entered (e.g., using the input device) to perform the method described above and to generate output information. The output information is applied to one or more output devices (e.g., a display screen of the computer).

In at least some cases, it may be advantageous if each program is implemented in a high level procedural or object-oriented programming language such as C++, Java, or Perl to communicate with a computer system. However, the programs can be implemented in assembly or machine language, if desired. In any case, the language may be a compiled or interpreted language.

In at least some cases, it is advantageous if each such computer program is stored on a storage medium or device, such as ROM or magnetic diskette, that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

Other embodiments are within the scope of the invention. For example, all or a portion of the system and/or method may be used on a wireless or optical network or any ring topical system, such as a DWDM (dense wavelength division multiplexing) based system.

Having described the invention and a preferred embodiment thereof, what we claim as new and secured by Letters Patent is:

1. A method for configuring a ring having a plurality of nodes connected by first and second channels, said method comprising:
providing a distributing filter that is configured to direct a first type of data to the first channel in the ring and a second type of data to the second channel in the ring;
detecting a fault on at least one of the first and second channels in the ring; and
adjusting the distributing filter to redirect data in the ring to avoid the fault.

2. The method of claim 1, further comprising:
providing both first and second types of data to a node in the ring.

3. The method of claim 1, wherein the first type of data includes high priority data and the second type of data includes low priority data.

4. The method of claim 3, further comprising:
providing both high and low priority data to a node in the ring.

5. The method of claim 1, further comprising:
providing a first mechanism that includes a first receiver communicating with the first channel and a first transmitter communicating with the second channel; and
providing a second mechanism that includes a second transmitter communicating with the first channel and a second receiver communicating with the second channel.

6. A method for configuring a ring having a plurality of nodes connected by first and second channels, said method comprising:
providing a priority filter that is configured to direct high priority data to said first channel in the ring and low priority data to said second channel in the ring;
sending, from a first node to a second node by way of said first channel, a first fault signal indicative of a signal fault, said first and second nodes being selected from said plurality of nodes;
detecting, at a second node by way of said second channel, information indicative of said signal fault, said second node being selected from said plurality of nodes;
in response to said first fault signal and said information indicative of said signal fault, forming a first bridge at said second node;
sending an acknowledgment signal from said second node to said first node by way of said second channel; and
in response to said acknowledgement signal, adjusting the priority filter to redirect data in the ring to avoid the signal fault.

7. The method of claim 6 wherein detecting said information comprises detecting a loss of signal on said second channel.

8. The method of claim 6 wherein said first node transmits, by way of said second channel, a second fault signal indicative of said signal fault, and detecting said information comprises detecting said second fault signal.

9. The method of claim 6 further comprising routing said first fault signal and said acknowledgement signal through a third node selected from said plurality of nodes.

10. The method of claim 6 wherein redirecting data in the ring comprises directing data traffic inbound to said first node on said second channel outbound from said first node on said first channel.

11. The method of claim 10 wherein redirecting data in the ring comprises directing data traffic inbound to said second node on said first channel outbound from said second node on said second channel.

12. The method of claim 6 wherein forming said second bridge comprises directing data traffic inbound to said second node on said first channel outbound from said second node on said second channel.

13. The method of claim 6 further comprising detecting said signal fault.

14. The method of claim 13 wherein detecting said signal fault comprises detecting a loss of signal on said first channel.

15. The method of claim 13 wherein detecting said signal fault comprises detecting a degradation of a signal on said first channel.

16. A data redirection apparatus for a network node on a ring having a plurality of network nodes connected by first and second channels, said switching apparatus comprising:
a data redirection request generator for generating, in response to a signal fault on said first channel, a redirection request signal for transmitting to a second node by way of said first channel, said second node being selected from said plurality of nodes;
an acknowledgement detector for detecting an acknowledgement signal on said second channel from said second node, said acknowledgement signal being generated in response to said fault signal; and
a priority filter having a first mode in which data on said first channel is not directed to said second channel and a second mode in which data on said first channel is directed to said second channel, said priority filter transitioning from said first mode to said second mode in response to said acknowledgment signal.

17. The data redirection apparatus of claim 16, further comprising:
a media access controller (MAC) in communication with the priority filter;
a first physical layer interface device (PHY) serving as an interface between the first channel and the MAC; and
a second PHY serving as an interface between the second channel and the MAC.

18. The data redirection apparatus of claim 16, further comprising:
a data redirection bridge responsive to the redirection request signal for redirecting data traffic.

19. The data redirection apparatus of claim 16, further comprising:
a signal fault detector for detecting the signal fault.

20. The data redirection apparatus of claim 19, wherein the signal fault detector detects a loss of signal.
